(19) United States
(12) Patent Application Publication
(10) Pub. No.: US 2006/0189475 A1
(43) Pub. Date: Aug. 24, 2006

(54) Compositions and methods for recycling of nanostructured sorbents

(76) Inventors: Viktor I. Petrik, S. Petersburg (RU); Alexander Bobarykin, Orange, CA (US)

Correspondence Address: ROBERT D. FISH;RUTAN & TUCKER LLP, 611 ANTON BLVD 14TH FLOOR, COSTA MESA, CA, 92626-1931, US

(21) Appl. No.: 11/064,881

(22) Filed: Feb. 23, 2005

(51) Int. Cl. B01J 19/12

(52) U.S. Cl. 502/56; 422/211; 422/186.01

(57) ABSTRACT

Non-porous carbonaceous and nanostructured adsorbent materials are regenerated using mechanical force or electromagnetic energy such that adsorption capacity is restored to at least 70-90%, and higher. Surprisingly, and in stark contrast to activated charcoal, the inventors discovered that the contaminant can be expelled from the non-porous material using simple pressure or centrifugation, even if the adsorbed material is present in a 20-fold and even higher amount relative to the weight of the adsorbent materials. In further aspects of the inventive subject matter, the adsorbed compound can also be destroyed by ballistic electrons emitted from the non-porous carbonaceous and nanostructured adsorbent material using microwave irradiation.

### FIELD OF THE INVENTION

The field of the invention is recycling generation of nanostructured sorbents, especially where the sorbent is a nanostructured carbonaceous sorbent.

### BACKGROUND OF THE INVENTION

Activated charcoal is a common sorbent for numerous compounds, and in most cases, the sorption characteristics and capacity is determined by the chemical nature of the compound, as well as on the pore size and distribution of pores in the activated charcoal. However, regeneration becomes increasingly difficult with increasing sorption capacity as the adsorbed compounds need to be released from an intricate network of nano-, meso, and macropores.

For example, many adsorbed compounds can be removed from the activated charcoal by physical methods, including heating the charcoal using indirect heat as described in GB 2007814 and U.S. Pat. No. 2,086,561. Vacuum desorption may be assisted with heating to remove heavy components from the charcoal as taught in U.S. Pat. Nos. 3,768,232 or 5,268,343. While such methods tend to regenerate at least some portion of the adsorbed compounds, residual quantities of the adsorbed compounds tend to build up in the smaller pores and therefore reduce the sorption characteristic over time. Moreover, heating may also lead to thermal decomposition of bound compounds, which may further reduce the binding capacity of the activated charcoal.

To reduce the problems associated with heat decomposition, compounds may also be removed from the activated charcoal using solvents or gases as described in GB 1397080 or GB 1573349 in which steam and/or hydrogen is employed as a stripping gas. In another example, as described in U.S. Pat. No. 5,807,424, an activated charcoal filter is washed with water, or with organic solvents to displace halogenated solvents from the charcoal as taught in U.S. Pat. No. 5,300,468. However, such methods are often limited by equilibrium adsorption of the solvent, or require excessive regeneration times to achieve reasonable regeneration.

In still further known methods, activated charcoal is chemically and/or electrochemically regenerated by oxidation of the compounds using in situ generated hydroxy radicals as described in U.S. Pat. No. 4,261,805. Alternatively, compounds may also be desorbed in a process in which the activated charcoal is employed as an electrode as described in U.S. Pat. No. 3,730,885 or U.S. Pat. App. No. 2004/0187685. However, most electrochemical processes require that the charcoal is in electrode form. Moreover, the activated charcoal also needs to be immersed in an electrolyte, which must subsequently be removed.

Recently, nanostructured carbonaceous adsorbents have been reported in our copending U.S. patent applications. Remarkably, such nanostructured adsorbents have substantially higher adsorption capacities as compared with activated charcoal (typically at least 50-300 times when compared on a weight basis), but are substantially non-porous. Due to the non-porous nature of such materials, all or almost all of the known regeneration methods will either fail to regenerate such materials, or include process steps that are superfluous and therefore incur additional costs.

Thus, while numerous compositions and methods are well known in the art to regenerate activated charcoal, various disadvantages remain. Moreover, most of such methods are less effective, or inappropriate for non-porous nanostructured adsorbents. Consequently, there is still a need to provide compositions and methods for recycling of nanostructured sorbents.

### SUMMARY OF THE INVENTION

The present invention is directed to devices and methods of regeneration of carbonaceous sorbents, and particularly nanostructured carbonaceous sorbents. In most preferred aspects, such regeneration is effected by a separator that imparts a mechanical force, a thermal, and/or an electromagnetic energy to the non-porous carbonaceous material at a strength effective to remove at least 70% of the quantity of the contaminant.

In one exemplary aspect of the inventive subject matter, a regenerator has a separator that is in contact with a non-porous carbonaceous material to which a quantity of a contaminant is adsorbed. Typically, the separator is configured to deliver a mechanical force to the non-porous carbonaceous material at a strength effective to remove at least 70%, more typically at least 80%, and most typically at least 90% of the quantity of the contaminant. Preferably, the separator is configured as a press or rotating container, which may allow continuous feeding of the non-porous carbonaceous material to the regenerator.

In another exemplary aspect of the inventive subject matter, the separator is configured to deliver at least one of a thermal and an electromagnetic energy to the carbonaceous material at a amount effective to remove at least 70%, more typically at least 80%, and most typically at least 90% of the quantity of the contaminant. Preferably, the separator comprises a magnetron that is configured to deliver microwave energy to the material such that the non-porous carbonaceous material emits electrons at an energy effective to at least partially destroy the contaminant.

In a still further exemplary aspect of the inventive subject matter, the regenerator includes a container that is coupled to an energy delivery portion, wherein the container at least partially encloses a non-porous carbonaceous material to which a contaminant to adsorbed. The energy delivery portion is preferably configured to deliver energy (e.g., kinetic energy, electromagnetic energy, and/or thermal energy) to the carbonaceous material in an amount sufficient to separate the contaminant from the carbonaceous material.

In most of the preferred aspects, the non-porous carbonaceous material comprises a plurality of particles that have a smallest dimension of less than 50 nm, and even more preferably graphene, while the contaminant is selected from the group of a metal, an optionally substituted hydrocarbon, a solvent, and an acid.

Consequently, contemplated methods of regenerating a non-porous carbonaceous material will include a step in which a container and an energy delivery portion are provided. In a further step, a non-porous carbonaceous material is provided to which a contaminant is adsorbed, wherein the non-porous carbonaceous material has a sorption capacity for the contaminant. In still another step, the non-porous carbonaceous material to which the contaminant is adsorbed is placed within the container such that the container at least partially encloses the non-porous carbonaceous material, and in yet another step, energy is delivered to the carbonaceous material in an amount sufficient to separate the contaminant from the carbonaceous material, and to thereby regain at least 80% of the sorption capacity.

Various objects, features, aspects and advantages of the present invention will become more apparent from the figures and the following detailed description of preferred embodiments of the invention.

### BRIEF DESCRIPTION OF THE DRAWING

FIG. 1A is a scanning electron micrograph of an exemplary sample of non-porous carbonaceous material.

FIG. 1B is a scanning electron micrograph of an exemplary sample of activated charcoal (highly porous carbonaceous material).

### DETAILED DESCRIPTION

The inventors have discovered that non-porous carbonaceous materials to which various contaminants are adsorbed can be effectively regenerated in a conceptually simple manner by subjecting the non-porous carbonaceous material to mechanical and/or electromagnetic energy. Where mechanical energy is employed, centrifugal and/or compressive forces are particularly preferred, while microwave irradiation (most preferably to effect ballistic electron emission) is a preferred electromagnetic energy. Using such regeneration, adsorption capacity can be almost entirely restored (typically at least 85-95%).

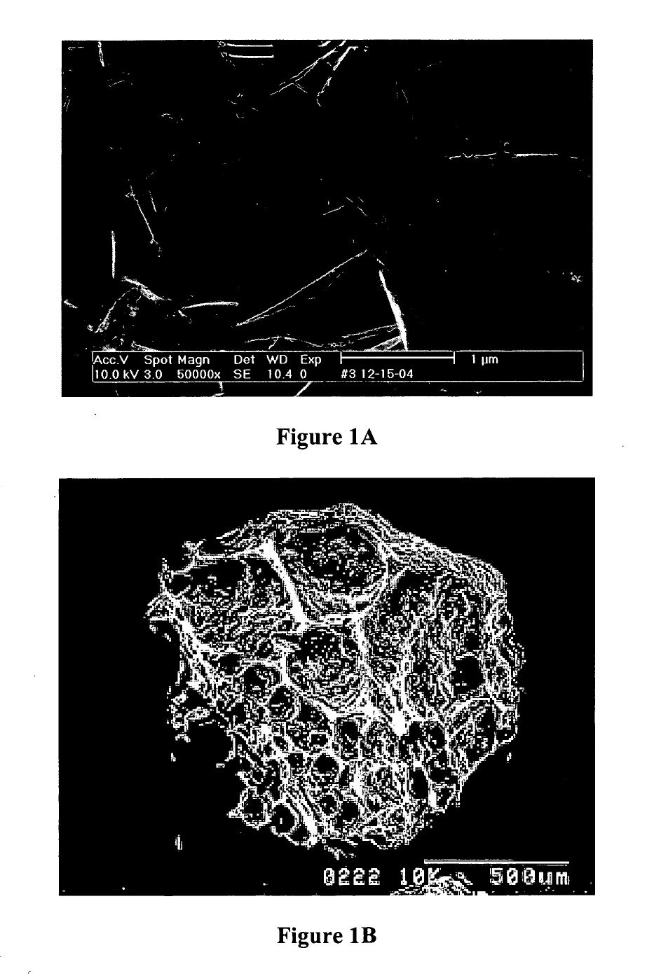

As used herein, the term “non-porous” in conjunction with a material refers to a porosity (i.e., void space within the material itself) of the material of less than 5 vol %, and even more typically of less than 2 vol %. For example, a material having a total volume of 10 cubic micrometer is considered non-porous is that material has a total pore volume of less than 0.5 cubic micrometer. It should be noted that the annular space defined by a carbocyclic ring is not considered a pore under the definition provided herein. Also, where a material has a contorted shape (e.g., a graphene in a wrinkled, sheet-like configuration) within a given volume, the void space between the material in that volume is not considered a pore under the definition provided herein. An exemplary non-porous nanostructured carbonaceous material according to the inventive subject matter is depicted in FIG. 1A, which is a scanning electron micrograph at a magnification of 50,000. In contrast, FIG. 1B depicts a typical porous activated charcoal grain in which macropores and mesopores can be clearly seen.

As also used herein, the term “carbonaceous” in conjunction with a material refers to a material that comprises at least 50 atom %, more typically at least 70 atom %, and most typically at least 90 atom % carbon. As further used herein, the term “nanostructured” in conjunction with a material refers to a material with a smallest dimension of equal or less than 100 nm, more typically less than 50 nm, and most typically less than 10 nm. Most preferably, contemplated nanostructured materials include graphene in an amount of at least 0.01 wt %, more typically at least 0.1 wt %, even more typically at least 1-10 wt %, and most more typically at least 10-95 wt %, and even more.

As still further used herein, the term “graphene” refers to a molecule in which a plurality of carbon atoms (e.g., in the form of five-membered rings, six-membered rings, and/or seven-membered rings) are covalently bound to each other to form a (typically sheet-like) polycyclic aromatic molecule. Consequently, and at least from one perspective, a graphene may be viewed as a single layer of carbon atoms that are covalently bound to each other (most typically sp² bonded). It should be noted that such sheets may have various configurations, and that the particular configuration will depend (among other things) on the amount and position of five-membered and/or seven-membered rings in the sheet. For example, an otherwise planar graphene sheet consisting of six-membered rings will warp into a cone shape if a five-membered ring is present the plane, or will warp into a saddle shape if a seven-membered ring is present in the sheet.

Furthermore, and especially where the sheet-like graphene is relatively large, it should be recognized that the graphene may have the electron-microscopic appearance of a wrinkled sheet. It should be further noted that under the scope of this definition, the term “graphene” also includes molecules in which several (e.g., two, three, four, five to ten, one to twenty, one to fifty, or one to hundred) single layers of carbon atoms (supra) are stacked on top of each other to a maximum thickness of less than 50 nanometers. Consequently, the term “graphene” as used herein refers to a single layer of aromatic polycyclic carbon as well as to a plurality of such layers having a thickness of less than 50 nanometers. Typically, the dangling bonds on the edge of the graphene are saturated with a hydrogen atom. The term “about” where used in conjunction with a numeral refers to a numeric range of +/−10% of the numeral, inclusive. For example, the term “about 100” refers to a numerical value of between 90 and 110, inclusive.

In one preferred aspect of the inventive subject matter, the inventors contemplate that the non-porous carbonaceous material is a bulk graphene preparation that is commercially available (e.g., from SupraCarbonic, 1030 West 17th Street, Costa Mesa, Calif. 92627). Alternatively, contemplated non-porous materials may also be prepared from graphite, coal, tar, etc. as described in our copending application with the Ser. No. 11/007614, which is incorporated by reference herein. Depending on the starting material, reaction conditions, and other parameters, the non-porous carbonaceous material will typically have a smallest dimension of less than 100 nm, more typically less than 50 nm, and most typically less than 10 nm.

It should be noted that (similar to purified carbon nanotubes) a significant fraction of the graphene material will aggregate to form a light-weight material in which the graphene layers typically have a contorted configuration. Where more disaggregated material or even isolated graphene layers are desired, it should be recognized that the aggregated material may be dispersed using chemical and/or physical treatments (e.g., one or more solvents [e.g., amine solvents], heat, microwave radiation, and/or ultrasound irradiation).

Still further contemplated alternative suitable non-porous carbonaceous materials include carbon fractals, branched nanotubes, and other irregularly shaped carbonaceous material so long as such material is non-porous and has a smallest dimension of less than 100 nm. Exemplary materials are disclosed in our copending application with the Ser. No. 11/007614 (supra). Additionally, it should be appreciated that the materials contemplated herein may be derivatized in numerous manners, and especially contemplated derivatizations include metal deposition (and especially with noble metals), derivatization with elements or compounds that produce semi-conductor characteristics (e.g., boron doped), and chemical modification of one or more carbon atoms within the graphene plane and/or edge. Most preferably, metal deposition is performed in which the metal provided from a gas phase (e.g., CVD, PVD, etc.), but other forms are also deemed suitable, including electroless deposition, electrolytic deposition, etc. Chemical modification of the graphene will generally follow known procedures for chemical derivatization of carbon nanotubes, which is well known in the art (e.g., exemplary covalent derivatization methods are described in J Mater. Res., Vol. 13, No. 9, (1998) p2423-2431; in Chem. Eur. J. 2003, 9, 4000-4008, or in U.S. Pat. Nos. 6,187,823, 6,426,134, WO 98/39250, and WO 00/17101, all of which are incorporated by reference herein). Non-covalent derivatization may be achieved by adding derivatized polycyclic aromatic compounds to the graphene compositions to achieve Van-der-Waals anchoring to the graphene.

Depending on the particular use and contaminant or other compound to be adsorbed, it should be recognized that the non-porous carbon composition may be disaggregated to at least some degree (e.g., to provide isolated graphene layers via solvent disaggregation and dilution), partially aggregated (e.g., to increase particle size), compacted, or even compressed to form a solid material that can be further reshaped if desired. Where the carbonaceous material is derivatized, it should be recognized that the derivatization groups may be employed to crosslink the carbonaceous material, or to covalently or non-covalently bind the carbonaceous material to another material. Furthermore, and especially where a relatively low density of the carbonaceous material is desirable, hydrophobic and/or hydrophilic fillers may be admixed to the carbonaceous material. For example, suitable fillers include glass fibers, polymeric fibers, vermiculite, fumed silica, mineral products (e.g., clay, carbonates), etc. While not limiting to the inventive concept presented herein, it is typically preferred that the carbonaceous non-porous material is used in bulk quantities, which are typically quantities of at least 0.5 gram, more typically at least 5 gram, even more typically at least 50 gram, and most typically at least 500 gram.

Most typically, the non-porous carbonaceous material is in bulk format without additional binder or filler, and may be enclosed in a carrier (e.g., pillow, envelope, boom, filter, etc.). However, in alternative aspects of the inventive subject matter, the non-porous carbonaceous material may be admixed, embedded, coated, or enclosed with a binder, filler, to other material (e.g., to provide particular form or structure, or to impart a desirable physicochemical characteristic). Thus, it should be recognized that the non-porous carbonaceous material may be pre-processed to separate the additional material at least in part from the non-porous carbonaceous material. For example, where the non-porous carbonaceous material is embedded in a porous and rigid structural scaffold, the non-porous carbonaceous material may be isolated from the scaffold by crushing the scaffold. Since the physical density of the non-porous carbonaceous material is typically between 0.01 and 0.001 g/cm³, separation of the scaffold material may be done by sifting or cyclone separation. Similarly, the non-porous carbonaceous material may be isolated from a binder or carrier by flotation as preferred non-porous carbonaceous material are substantially completely hydrophobic (adsorb less than 0.1 wt % water, more typically less than 0.01 wt % as measured after mixing in water and subsequent withdrawal of water from the material via Buechner filter using tap vacuum). Further contemplated pre-processing includes combustion of the non-porous carbonaceous material, shredding, comminuting, aliquoting, heating, and washing (e.g., with aqueous and/or organic solvents).

In still further contemplated aspects, the non-porous carbonaceous material may also remain at least partially, and more typically entirely in contact with an enclosing material. For example, where the non-porous carbonaceous material is enclosed in an envelope, pillow, or boom, it is contemplated that the envelope, pillow, or boom is directly subjected to the regeneration process. Similarly, where the non-porous carbonaceous material is enclosed in a filter structure and where the regeneration involves microwave radiation, the non-porous carbonaceous material may remain in the filter.

With respect to the contaminant or other compound that is adsorbed to the non-porous carbonaceous material, it is generally preferred that the non-porous carbonaceous material is loaded at least with 50 wt % of the contaminant or other compound. However, and more typically it is preferred that the contaminant or other compound is adsorbed on the material in an amount of at least the same weight (with respect to the non-porous carbonaceous material), more preferably at least five times the weight, even more preferably at least ten times the weight, and most preferably at least twenty times the weight of the non-porous carbonaceous material. Of course, it should be recognized that contemplated non-porous carbonaceous materials may adsorb more than one type of compound. Particularly suitable contaminants and compounds that can be adsorbed to contemplated materials include optionally substituted hydrocarbons (e.g., linear, branched cyclic, or polycyclic), wherein suitable substituents include halogens, alkyls, nitrogen containing groups (e.g., secondary or tertiary amines, amides, imides), oxygen-containing groups (e.g., ether, alcohol, aldehyde, acid, ester), and sulfur-containing groups (e.g., thiols, thioesters, disulfides, etc.). Such hydrocarbons may be saturated, contain one or more double bonds, and/or may be aromatic. Additionally contemplated contaminant or other compound include metals (and especially mercury), organic and inorganic acids, oil-based paint, and volatile organic compounds (VOC) having a boiling point at or below room temperature (about 20° C.).

An exemplary listing of compounds that can be adsorbed by the non-porous carbonaceous materials presented herein is listed in Table 1 in comparison with adsorption capacities for the same compounds using granulated activated carbon. In Table 1 below, NPC refers to non-porous carbonaceous material, GAC refers to granulated activated charcoal, and the numerical values given in the columns refer to gram of contaminant adsorbed per gram of MPC or GAC. The ratio of adsorption using NPC and GAC are indicated in the last column as absolute fold difference.

TABLE 1

| CONTAMINANT | NPC | GAC | RATIO NPC:GAC |
|---|---|---|---|
| Acetonitrile | 32.1 | 0.244 | 131.56 |
| Benzene | 31.63 | 0.272 | 116.28 |
| Chloroform | 24.55 | 0.264 | 92.99 |
| Crude Oil | 74.51 | 0.19 | 392 |
| Dichloromethane | 32.76 | 0.204 | 160.58 |
| Diesel | 36.65 | 0.222 | 165 |
| Gasoline | 29.76 | 0.28 | 106.28 |
| Hexane | 27.54 | 0.262 | 105.11 |
| Isopropyl Alcohol | 22.79 | 0.212 | 107.5 |
| Kerosene | 40.16 | 0.224 | 179.28 |
| Mineral Spirits | 29.21 | 0.188 | 155.37 |
| Naphtha | 24.14 | 0.202 | 119.5 |
| Nitric Acid | 51.33 | 0.208 | 246.77 |
| Phosphoric Acid | 60.28 | 0.232 | 259.82 |
| Sulfuric Acid | 36.54 | 0.218 | 167.61 |
| Tetrachloroethene | 38.22 | 0.282 | 135.53 |
| Toluene | 34.89 | 0.19 | 183.63 |
| Turpentine | 26.68 | 0.178 | 149.88 |
| Xylenes | 38.61 | 0.194 | 199 |

In further preferred aspects of the inventive subject matter, the inventors contemplate that the regenerator includes a separator that is in contact with a non-porous carbonaceous material to which a quantity of contaminant is adsorbed, wherein the separator is configured to deliver a mechanical force to the non-porous carbonaceous material at a strength effective to remove at least 20%, more typically at least 50%, even more typically at least 70%, and most typically at least 90% of the quantity of the contaminant.

Most typically, the mechanical force in contemplated separators is a centrifugal and/or compressive force that is applied to the non-porous carbonaceous material to which the contaminant is adsorbed. For example, suitable separators may include one or more pairs of rollers that receive and compress the non-porous carbonaceous material to thereby expel the adsorbed compound. Such configurations are particularly advantageous where the non-porous carbonaceous material remains enclosed in a container from which the adsorbed material can be removed. Alternatively, compressive forces may also be provided by two or more corresponding elements that receive and compress the non-porous carbonaceous to which the contaminant or other material is adsorbed. In still further exemplary configurations, compressive forces may be realized by pushing the non-porous carbonaceous material against one or more sieves or other structure that largely retain the non-porous carbonaceous material while allowing the previously adsorbed material to pass through. Compressive forces will typically be in the range of about 0.1 psi to about 10,000 psi, and most typically between 10 psi to about 1000 psi. Similarly, where centrifugal force is applied, forces will typically be in the range of 10-50,000 xg, and more typically between 50-5,000 xg.

Similarly, centrifugal forces may be provided by placing the non-porous carbonaceous material in a rotating drum or cylinder from which the adsorbed material can be drained (e.g., through openings in the cylinder wall) or otherwise removed. Typically, higher rotational speed will increase the degree of removal of the adsorbed material from the non-porous carbonaceous material. Depending on the particular configuration, it should be recognized that the non-porous carbonaceous material can be fed in a continuous manner (e.g., using a vortex-based separator or flow-through-type centrifuge) to allow continuous regeneration of the non-porous carbonaceous material. Of course, it should be recognized that compressive forces and centrifugal forces may be combined in a regeneration device. For example, a contaminant may first be removed from the non-porous carbonaceous material in a roller press while disposed within a boom, pillow, or envelope. In a subsequent step, residual contaminant is then removed from the non-porous carbonaceous material via centrifugation, wherein the non-porous carbonaceous material may be removed from the boom, pillow, or envelope.

Using centrifugation of non-porous carbonaceous material to which the contaminant was adsorbed, the inventors repeatedly (>50 times) regenerated the non-porous carbonaceous material from crude oil that was present in an amount of more than fifty times the weight of the non-porous carbonaceous material, wherein the adsorption capacity after centrifugal regeneration was substantially unchanged (here: >96%). Additional experiments using most of the compounds listed in Table 1 above provided similar results using compressive forces as well as centrifugal forces.

It should be noted that such conceptually simple regeneration is far from being trivial for several reasons. First, mechanical forces are unable to provide any significant regeneration for activated charcoal, which is porous. Any significant recovery of contaminant from activated charcoal using mechanical forces is typically accompanied by almost complete destruction of the activated charcoal, resulting in an almost completely abolished capability of subsequent adsorption. Second, it is further unexpected that high degrees of regeneration can be achieved in light of the enormous adsorption capacity of the non-porous carbonaceous material. Ordinarily, one would expect that substantial quantities of the adsorbed material would be lost in the space formed between the nanostructured material. However, and among other factors, due to the compressibility of the non-porous carbonaceous material, all or almost all of the previously adsorbed material can be recovered. Furthermore, while not limiting to the inventive subject matter, it is contemplated that regeneration using mechanical forces is also facilitated by the moderate strength of adsorption of the contaminants to the non-porous carbonaceous material, which is in strong contrast to the entrapment of various contaminants in the micro- and nanopores of activated charcoal. Viewed from another perspective, contaminant adsorption in non-porous materials is thought to be effected by hydrophobic, electrostatic, and/or Van-der-Waals interactions, while contaminant adsorption in activated charcoal is predominantly due to physical entrapment of the contaminant in a pore (similar to size exclusion chromatography or molecular sieving chromatography).

Alternatively, and especially where the contaminant is ecologically problematic and/or a health hazard, it is contemplated that the separator may also be configured to deliver at least one of a thermal and an electromagnetic energy to the carbonaceous material in an amount effective to remove and/or destroy at least 20%, more typically at least 50%, even more typically at least 70%, and most typically at least 90% of the quantity of the contaminant. Most typically, where the contaminant is destroyed in situ (i.e., while adsorbed to, or in close proximity [i.e., within 1 mm] of non-porous carbonaceous material) using microwave irradiation, the weight ratio of contaminant to non-porous carbonaceous material is equal or less than 10:1, more typically less than 5:1, and most typically less than 1:1. However, higher ratios are not necessarily excluded.

Typical contaminants to be adsorbed to the non-porous carbonaceous materials include toxic agents (and particularly chemical warfare agents), halogenated solvents, heat exchange and dielectric fluids in transformers and capacitors, hydraulic and lubricating fluids, diffusion pump oils, plasticizers, and paints. Among other particularly contemplated compound are halogenated, and especially chlorinated biphenyls, polyhalogenated (typically polychlorinated) dibenzofurans, and polyhalogenated (typically polychlorinated) dibenzodioxins.

Consequently, suitable regenerators will include one or more magnetrons, wherein the microwave energy and frequency from the magnetron(s) is preferably selected such that the non-porous carbonaceous material emits electrons at an energy effective to at least partially destroy the contaminant. For example, suitable frequencies include those between 1.0-4.5 GHz, and most preferably 2.45 GHz, while preferred energies will typically fall within the range of several hundred to several thousand (and even several ten thousand) Watt. Especially preferred configurations include those described in our copending U.S. application with the Ser. No. 11/007612, which is incorporated by reference herein. With respect to the irradiated material, it should be recognized that the non-porous carbonaceous material is a relatively good microwave susceptor. Therefore, and depending on the time and energy of microwave irradiation, the non-porous carbonaceous material will readily reach a temperature of between about 400° C. to about 2500° C., and even higher. Alternatively, or additionally, contemplated regenerators may also include a direct (e.g., flame, heat filament, etc.) or indirect heater (e.g., radiator, hot air blower, etc.) that assists in reparation of the adsorbed contaminant from the non-porous material.

It is further preferred that the container in which the non-porous carbonaceous material is irradiated is preferably hermetically sealed while the material is irradiated. Most typically, the container comprises a refractory material, and most preferably a ceramic inner wall. Irradiation products formed from the previously adsorbed materials are typically oxidized small molecules, including CO₂, and Cl₂, which can be vented to a suitable receiving portion (e.g., solvent trap, filter, etc.). Irradiation times will typically depend on the particular contaminant and quantity adsorbed, and it should be recognized that a person of ordinary skill in the art will readily be able to identify proper times. Where microwave energy is employed to desorb the adsorbed contaminant without significant destruction by ballistic electron emission, it is contemplated that the microwave energy is significantly reduced to effect predominantly inductive heating in the non-porous carbonaceous material. For example, the non-porous carbonaceous material can be irradiated with 200 W of microwave energy at 2.45 GHz for several seconds per 10 g to raise the temperature to several hundred degrees ° C.

In yet further contemplated aspects, and especially where the adsorbed contaminant comprises a defined composition (e.g., predominantly diesel fuel, gasoline, or crude oil) it should be recognized that the non-porous carbonaceous material to which the contaminant is adsorbed may also be incinerated. Most preferably, heat provided by such incineration may be employed to generate energy using a conventional steam cycle, or other manners well known in the art.

Remarkably, the non-porous carbonaceous material is thermally stable to a temperature of up to about 3000° C. Therefore, thermal decomposition of the bound contaminant is also considered suitable.

Where desirable, the non-porous carbonaceous material can be further processed after application of the mechanical force to further remove residual contaminant and/or decrease bulk density. For example, such processing steps may include physical treatments (e.g., radiant or inductive heating, mechanical agitation, ultrasound exposure, etc.), chemical treatments (e.g., dispersion in one or more solvents), electric treatments (e.g., adding static charges), and all reasonable combinations thereof.

In a still further contemplated aspects of the inventive subject matter, and especially where the contaminant comprises volatile hydrocarbons (which may or may not be substituted), it is preferred that the contaminant that has been removed from the non-porous carbonaceous material is captured (e.g., for sale as a commodity or for further processing) using a condensing element. Most preferably, the condensing element includes a refrigeration portion that is thermally coupled to a surface that includes non-porous carbonaceous materials. Upon contact of the volatile contaminant with the non-porous material on the cooled surface, it has been observed that the non-porous material adsorbs the contaminant, and that the so adsorbed contaminant is liquefied at a temperature that is above the boiling point of the contaminant. While not wishing to be bound by any theory or hypothesis, it is contemplated that adsorption of the contaminant will impart a higher degree of order (typically by reduction of the degrees of molecular motion), which will result in a facilitated transition from the gas phase to the liquid phase. For example, gasoline vapors (e.g., from regeneration devices, storage tank, or fill line) can be condensed on a heat exchanger grid or cartridge that is coated with the non-porous carbonaceous materials at a temperature of about −10 to −20° C. In contrast, known gasoline condensers typically need to be operated at a temperature of about −60 to −80° C. to condense gasoline vapors.

Therefore, viewed from a different perspective, the inventors contemplate a regeneration device that includes container coupled to an energy delivery portion, wherein the container at least partially encloses a non-porous carbonaceous material to which a contaminant to adsorbed, and wherein the energy delivery portion is configured to deliver energy (e.g., kinetic, electromagnetic, and/or thermal energy) to the carbonaceous material in an amount sufficient to separate the contaminant from the carbonaceous material. Typically, it is preferred that the energy delivery portion is configured such that the amount of energy is sufficient to regenerate at least 30%, more preferably at least 50%, more preferably at least 80%, and most preferably at least 95% of the sorbent capacity of the non-porous carbonaceous material.

Consequently, contemplated methods of regenerating a non-porous carbonaceous material will include at least one step in which a container and an energy delivery portion are provided. In another step, non-porous carbonaceous material is provided to which a contaminant is adsorbed, and in a further step, the non-porous carbonaceous material to which the contaminant is adsorbed is placed within the container such that the container at least partially encloses the non-porous carbonaceous material. In yet another step, energy is delivered to the non-porous carbonaceous material using the energy delivery portion in an amount sufficient to separate the contaminant from the carbonaceous material, and to thereby regain at least 30%, more preferably at least 50%, more preferably at least 80%, and most preferably at least 95% of the sorption capacity of the non-porous carbonaceous material.

Thus, specific embodiments and applications of compositions and methods for recycling of nanostructured sorbents have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

What is claimed is:

1. An apparatus comprising a separator in contact with a non-porous carbonaceous material to which a quantity of contaminant is adsorbed, and wherein the separator is configured to deliver a mechanical force to the non-porous carbonaceous material at a strength effective to remove at least 70% of the quantity of the contaminant.

2. The apparatus of claim 1 wherein the separator is configured as at least one of a press and a rotating container.

3. The apparatus of claim 1 wherein the separator is configured to allow continuous feeding of the non-porous carbonaceous material to the separator.

4. The apparatus of claim 1 wherein the non-porous carbonaceous material comprises graphene, and wherein the contaminant is selected from the group of an optionally substituted hydrocarbon, a solvent, a metal, and an acid.

5. The apparatus of claim 1 wherein the non-porous carbonaceous material comprises a plurality of particles that have a smallest dimension of less than 50 nm.

6. An apparatus comprising a separator in contact with a non-porous carbonaceous material to which a quantity of contaminant is adsorbed, and wherein the separator is configured to deliver at least one of a thermal and an electromagnetic energy to the carbonaceous material at a amount effective to remove at least 70% of the quantity of the contaminant.

7. The apparatus of claim 6 wherein the separator comprises a magnetron, and wherein microwave energy from the magnetron is selected such that the non-porous carbonaceous material emits electrons at an energy effective to at least partially destroy the contaminant.

8. The apparatus of claim 6 wherein the non-porous carbonaceous material comprises at least one of a plurality of particles that have a smallest dimension of less than 50 nm and graphene, and wherein the contaminant is selected from the group of a metal, an optionally substituted hydrocarbon, a solvent, and an acid.

9. An apparatus comprising:
a container coupled to an energy delivery portion;
wherein the container at least partially encloses a non-porous carbonaceous material to which a contaminant to adsorbed; and
wherein the energy delivery portion is configured to deliver energy to the carbonaceous material in an amount sufficient to separate the contaminant from the carbonaceous material.

10. The apparatus of claim 9 wherein the energy delivery portion is configured such that the amount of energy is sufficient to regenerate at least 80% of a sorbent capacity of the non-porous carbonaceous material.

11. The apparatus of claim 9 wherein the energy delivery portion delivers at least one of a kinetic energy, electromagnetic energy, and thermal energy.

12. The apparatus of claim 9 wherein the energy delivery portion is configured to impart a rotating movement to the container.

13. The apparatus of claim 9 wherein the energy delivery portion is configured to impart a thermal energy to the container.

14. The apparatus of claim 9 wherein the non-porous carbonaceous material comprises graphene.

15. The apparatus of claim 9 wherein the non-porous carbonaceous material is retained in an enclosing structure.

16. A method of regenerating a non-porous carbonaceous material, comprising:
providing a container and an energy delivery portion;
providing a non-porous carbonaceous material to which a contaminant is adsorbed, the non-porous carbonaceous material having a sorption capacity for the contaminant;
placing the non-porous carbonaceous material to which the contaminant is adsorbed within the container such that the container at least partially encloses the non-porous carbonaceous material; and
delivering energy to the non-porous carbonaceous material using the energy delivery portion in an amount sufficient to separate the contaminant from the carbonaceous material, and to thereby regain at least 80% of the sorption capacity.

17. The method of claim 16 wherein the energy delivery portion comprises a magnetron that delivers microwave energy such that the non-porous carbonaceous material emits electrons at an energy effective to at least partially destroy the contaminant.

18. The method of claim 16 wherein the energy delivery portion comprises a press or a rotating container.

19. The method of claim 16 wherein the non-porous carbonaceous material comprises at least one of a plurality of particles that have a smallest dimension of less than 50 nm and graphene.

20. The method of claim 16 wherein the contaminant is present in an amount of at least ten fold a weight of the non-porous carbonaceous material.
